(19) United States
(12) Patent Application Publication
(10) Pub. No.: US 2026/0368252 A1
(43) Pub. Date: Nov. 19, 2026

(54) DATA PROCESSING FOR REAL-TIME DATA GRAPHS AND PERSONALIZATION

(71) Applicant: Salesforce, Inc., San Francisco, CA (US)

(72) Inventors: Shyam Sundar Rao Mankala, HULIMAVU (IN); Tapas Kumar Nayak, Redmond, WA (US); Deepak Pushpakar, Bangalore (IN); Qiyuan Hu, Redmond, WA (US); Amit Kumar Ghosh, Redmond, WA (US); Noah John Gray, Seattle, WA (US); Harsh Sharma, Jodhpur (IN); Danny Polonsky, Ramat Gan (IL); Vishal Sood, Bangalore (IN); Jawad Ahmed Ibrahim Katib, Sammamish, WA (US)

(21) Appl. No.: 19/206,999

(22) Filed: May 13, 2025

(51) Int. Cl. G06F 16/901; G06F 16/28; G06F 16/9535

(52) U.S. Cl. CPC G06F 16/9024; G06F 16/285; G06F 16/9535

(57) ABSTRACT

Techniques for data processing for real-time data graphs and personalization are discussed herein. A system may receive user data including a first user action at a real-time layer of the system, the real-time layer including a first real-time data graph. The system may also determine a first identifier associated with the user data. The first real-time data graph may be updated to include an indication of the first identifier. The user data may include a second user action associated with a second identifier, and the system may generate a second real-time data graph. The system may determine that the first identifier corresponds to the second identifier, and may merge the real-time data graphs to generate a unified real-time data graph. The unified real-time data graph may be used by the system to determine real-time personalization data, such as updating and or generating a unified user profile.

### TECHNICAL FIELD

Companies may use one or more systems and/or platforms to perform various tasks. In some cases, systems and/or platforms may receive user data associated with a company (e.g., customer data). However, when requesting that the systems/or platforms perform an operation using such data for user personalization, the operations may result in an undesirable user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates a schematic view of an example system for data processing for real-time data graphs and personalization.

FIG. 2 illustrates a system-architecture diagram of an example system in which a system uses a real-time layer and storage layer for user data processing.

FIG. 3 illustrates a block diagram including an example process for real-time computations on user data for real-time data graphs.

FIG. 4 illustrates a block diagram including an example process for user segmentation for real-time data graphs.

FIG. 5 illustrates an example environment for performing techniques described herein.

FIG. 6 is a flow diagram illustrating an example process of data processing using real-time data graphs for personalization.

### DETAILED DESCRIPTION

Techniques for data processing for real-time data graphs and personalization are discussed herein. As described throughout, systems can process user data and update real-time data graphs, where the real-time data graphs may be leveraged such that personalization data can be used in real time. In some examples, a system may receive user data including a first user action (e.g., browsing a webpage, clicking a user interface component, etc.). The first user action may be received at a real-time layer of the system, the real-time layer including a first real-time data graph. The system may also determine an identifier associated with the user data. An identifier may include a profile identification, an email identification, a cookie identification, and/or the like. The first real-time data graph may be updated to include an indication of the identifier such that the identifier comprises a user profile (e.g., personalization data). Subsequently, the real-time layer may receive a second user action, and may also include a second real-time data graph. The real-time layer may determine a second identifier associated with the second user data, and update the second real-time data graph accordingly. Further, the system may be configured to leverage the identifiers to find a correlation. For example, the system may determine that the first identifier corresponds to the second identifier (e.g., they are the same cookie identification). Based on the first and second identifier corresponding, the system may merge the first and second real-time data graph to generate a unified real-time data graph. The unified real-time data graph may be used by the system to determine real-time personalization data. For example, the unified real-time data graph may be used to update and or generate a unified user profile, the unified user profile containing personalization data associated with both the first real-time data graph and the second real-time data graph. Additionally, or alternatively, real-time personalization data may be used to generate one or more personalized outputs for a user. As discussed throughout this disclosure, the techniques may improve the user experience by allowing the system to generate and/or update personalization data in real time, such that particular user engagements are immediately available in a user profile, and usable to make decisions and personalize interactions before a user's subsequent engagement.

When personalizing a user experience of an application, such as a web application, mobile application, customer relationship management (CRM) platform, and/or the like, it may be beneficial to provide such personalization in real time. Personalizing a user experience may be context-driven. For example, companies (e.g., organizations), and/or users may rely on various systems to store and manage user (e.g., customer) data. In such cases, vast amounts of user data (e.g., actions such as engagement, transactions, and/or the like) may be received by a system. In some situations, the system may process an event, or receipt of user data, using a data graph. However, based on particular business functions and/or needs, a company may require real-time analytics, decision-making, and customer engagement for particular events. Accordingly, the systems and/or techniques described herein may improve user experience and increase business efficiencies by personalizing user interactions in real time. Further, the use of real-time data graphs (e.g., a data graph accessed with low latency) that are tailored to real-time applications improve the utilization of computing resources by decreasing latency in processing user data in real time, while also requiring fewer instances of computing resources (e.g., CPU, GPU, RAM, etc.) for processing user data where real-time responses are not critical. Additionally, maintaining a data graph of the storage layer optimizes efficiencies in relating objects in a data cloud.

To address these and other technical problems and inefficiencies, the systems and/or techniques described herein may include a real-time layer (which may also be referred to as a “real-time component”) configured to process user data (e.g., user data requiring real-time interactions) using an instance of a data graph that is accessed through the real-time component with low latency, while also processing user data with an instance of the data graph at a storage layer (which may be referred to as a “storage component.” Further, before getting updated into a real-time data graph, user data requiring real-time interactions may be processed for further insights and personalization. The technical solutions discussed herein solve one or more technical problems associated with data processing which may negatively impact the user experience with high-latency processing, as well as inefficient use of computing resources.

In some examples, a system (e.g., a personalization system) may be supported by a data cloud service, or platform, including computing servers, data centers, and/or a cloud computing network. A data cloud service may be, or comprise, a data cloud provider network. A data cloud provider network (sometimes referred to simply as a “data cloud”) may refer to a pool of network-accessible computing resources (such as compute, storage, and networking resources, applications, and services), which may be virtualized or bare-metal. The data cloud can provide convenient, on-demand network access to a shared pool of configurable computing resources that can be programmatically provisioned and released in response to user commands. In other instances, however, a data cloud service may be an on-premises network, a private network of a corporation, and/or any other type of network or combination thereof.

The system may include one or more components configured to store and/or analyze data (e.g., a data warehouse, data lake, etc.). For example, the system may include one or more storage layers and/or platforms. The system may include a storage layer (e.g., a data warehouse, data lake, and/or a combination thereof (“a data lakehouse”)) and a low-latency storage layer (which may be referred to as a “a real-time layer”). Additionally, or alternatively, the system may be, or comprise, a service provider offering different built-in services to customers, users, etc. to help run their applications and services. For example, the system may include built-in services for computer applications such as a browser, application programming interface (API), software development kit (SDK), and/or the like.

The system may receive user data (e.g., an event). For example, the user data may be received by an SDK associated with the system. The user data may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data may be location data, voice data, financial data, and/or the like. For example, the user data may be, or comprise, a user action such as breaking a geofence, walking into a movie theatre, etc.

In some instances, the user data received by the system (e.g., via an SDK) may be sent to the real-time layer. The real-time layer may include one or more denormalized data graphs (hereinafter “real-time data graph”). A real-time data graph may correspond to a data graph of a storage layer that is accessed through the real-time layer with low latency. As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

By way of example, and not limitation, the real-time layer may receive user data corresponding to a user action (e.g., engagement) with a website. Based on the user action, a real-time data graph of the real-time layer may be updated. Based on the updated real-time data graph, the system may be configured to generate real-time personalization data. For example, real-time personalization data may comprise a user profile that has been updated in real-time. Based on the updated real-time data graph, the real-time personalization data may include an indication of previous context and the current (e.g., real-time) user data. Accordingly, based on the real-time personalization data, a user profile may include related attributes, or properties, of an individual (e.g., the user), an account, etc.

In some instances, when user data is received by the real-time layer, the system may be configured to perform one or more transformations before generating and/or updating one or more real-time data graphs. For example, the system may be configured to unify user profiles such that known and/or unknown user profiles may be connected (e.g., identity resolution). As described above, user data may comprise a user action at a web application, mobile application, and/or the like. Additionally, or alternatively, user data may indicate an identifier. An identifier may be a Hypertext Transfer Protocol (HTTP) cookie identifier, a device identifier, an authentication identifier, an email identifier, and/or the like. In some instances, an identifier may be associated with a known identity (e.g., known user profile). For example, an identifier may be associated with a known identity if the identifier has previously undergone authentication, is associated with Personally Identifiable Information (PII) data (e.g., phone number, name, email, etc.), is associated with a user-generated identifier, and/or the like. By way of example, and not limitation, user data may include a user action such as browsing at a web application, where the user may sign-in with an email identifier.

Additionally, or alternatively, an identifier may be associated with an unknown identity (e.g., unknown user profile). For example, an identifier may be associated with an unknown identity if the identifier has not previously undergone authentication, is not associated with PII data, is not associated with a user-generated identifier, and/or the like. By way of example, and not limitation, user data may include a user action such as browsing at a web application, but doing so anonymously. In such an example, the identifier may comprise a cookie identifier.

When user data is received by the real-time layer, the system may be configured to generate and/or update one or more real-time data graphs. As described above, a real-time data graph may be a denormalized instance of a data graph (e.g., a denormalized JSON structure) such that data retrieval is optimized. As such, the system may process the user data, update the real-time data graph, and generate real-time personalization data in real time (e.g., in less than 500 milliseconds). For example, the system may be configured to generate and/or update a real-time data graph based on one or more identifiers. In some instances, the real-time data graph defined by Profile DMO may be associated with an existing identification, or user profile. Continuing from the example above, upon receipt of user data including a user action such as browsing at a web application, where the user may sign in with an email identifier, the system may identify a known user profile based on the email identifier, and update the corresponding real-time data graph. For example, the system may update a real-time data graph defined by a Profile DMO such that the real-time data graph includes an indication of the user data and usable to generate real-time personalization data for a user profile. In some instances, the real-time data graph defined by the Profile DMO may also be associated with a new identification, or user profile. Additionally, or alternatively, upon receipt of user data including a user action such as browsing at a web application, where the user is doing so anonymously, the system may generate a real-time data graph including an indication of the cookie identifier, and in turn, an unknown user profile. For example, because the user is unknown, the system may generate a real-time data graph with a Profile DMO such that the real-time data graph includes an indication of the user data and usable to generate real-time personalization data for a user profile.

Additionally, or alternatively, the system may be configured to connect identifiers, or user profiles, and generate a unified data graph. For example, as described above, the system may receive user data including an action of anonymous web browsing (e.g., first user data), and generate a real-time data graph associated with a cookie identifier (e.g., a first real-time data graph), where the first real-time data graph may indicate real-time personalization data for an unknown profile. The system may also receive second user data. For example, second user data may include an action of a sign-in using an email identifier at the same web application (e.g., subsequent to anonymous web browsing). The system may update a real-time data graph associated with the email identifier (e.g., a second real-time data graph), where the second real-time data graph may indicate real-time personalization data for a known profile. For example, the real-time personalization data for a known profile may include PII data such as a name, phone number, etc. Based on the first user data and the second user data, the system may determine that the unknown profile corresponds to the known profile. Based on the profiles corresponding, the system may generate a unified real-time data graph that may indicate personalization data for a unified profile. For example, the unified real-time data graph may include an indication of the cookie identifier, the email identifier, and/or PII data. This way, an unknown profile and known profile may be unified. In other words, the unified real-time data graph for the unified user profile may include an indication of both the actions associated with the first user data when the profile was unknown, as well as the user data during which the profile was known.

In some instances, the system may be configured to unify an unknown profile and another unknown profile. For example, the system may receive first user data including an action of web browsing at a first device (e.g., using a first cookie identifier) and the use of an authentication identifier. The system may generate a real-time data graph associated with a first cookie identifier and the authentication identifier (e.g., a first real-time data graph). The first real-time data graph may indicate real-time personalization data for a first unknown profile (e.g., email and/or name is unknown). The system may also receive second user data. For example, second user data may include an action of a user browsing at a second device (e.g., using a second cookie identifier) and the use of the same authentication identifier (e.g., subsequent to the web browsing at the first device). The system may generate a real-time data graph associated with the second cookie identifier and the authentication identifier (e.g., a second real-time data graph). The second real-time data graph may indicate real-time personalization data for a second unknown profile. The system may determine, based on the first user data and the second user data, that the authentication identifier of the first unknown profile corresponds to the authentication identifier of the second unknown profile. Based on the authentication identifiers corresponding, the system may generate a unified real-time data graph that may indicate real-time personalization data for a unified profile. For example, the unified real-time data graph may include an indication of the first cookie identifier, the second cookie identifier, the authentication identifier, etc.

As described above, the system may determine that one or more identifiers correspond. For example, the system may determine that cookie identifiers correspond between an unknown profile and a known profile, and/or that authentication identifiers correspond between a first unknown profile and a second unknown profile. In some instances, the system may determine that one or more identifiers correspond based on one or more rules, or policies. For example, a rule may indicate identifiers associated with user data received at the real-time layer may correspond if they are an exact match. For example, the system may determine that the cookie identifiers correspond between the unknown profile and the known profile, where both cookie identifiers are “C111.” Additionally, or alternatively, the system may determine that the authentication identifiers correspond between the first and second known profiles, where both authentication identifiers are “12xd24.” In instances where the identifiers are not an exact match, the system may refrain from determining a correlation. In other words, the system may refrain from generating a unified real-time data graph, and the real-time data graphs are kept separate, and in turn, the user profiles.

In some instances, when user data is received by the real-time layer, the system may be configured to perform one or more transformations, such as determining one or more metrics (e.g., aggregations of data). As described above, the system may be configured to unify user profiles. For example, the system may unify real-time data graphs and, in turn, unify known and/or unknown profiles such that real-time personalization data is for one unified profile.

The system may also be configured to compute, or determine one or more metrics for a unified profile (e.g., showing a dimension between a unified profile, product, and/or the like). In other words, the system may determine calculated insights. For example, user data at a first time may indicate a user's first browsing actions, where the associated real-time data graph and first user profile may be updated based on the first browsing actions. User data for the same user at a second time may indicate the user's second browsing actions, where the associated real-time data graph and second user profile may be updated based on the second browsing actions. Using the techniques described herein, the first user profile and second user profile may be unified. Additionally, or alternatively, the system may aggregate the first browsing actions and second browsing to generate real-time aggregated data, the real-time aggregated data indicating the user's total browsing, lifetime value (LTV) of spending, and/or the like. The real-time aggregated data may be used by the system to update the relevant real-time data graph (e.g., the unified real-time data graph) for a unified user profile. In another example, user data at a first time may indicate a first user's purchase of a product. User data at a second time may indicate a second user's purchase of the same product. Using the techniques described herein, the real-time data graphs associated with each of the user's transactions may be updated and subsequently unified. Additionally, or alternatively, the system may aggregate the first user purchase and second user purchase to generate real-time aggregated data, the real-time aggregated data indicating the product's total purchases. The real-time aggregation may be used by the system to update the relevant real-time data graph (e.g., the unified real-time data graph) for a unified profile. In some examples, the real-time aggregated data may comprise real-time personalization data.

In some instances, when user data is received by the real-time layer, the system may be configured to perform one or more transformations, such as determining a real-time segment for a unified profile. (e.g., segmentation). A real-time segment may be determined based on personalization data associated with a unified user profile. Additionally, or alternatively, a real-time segment may be determined based on a unified user profile including real-time aggregated data. A real-time segment may indicate a particular category, threshold, attribute, and/or the like. By way of example, and not limitation, based on real-time personalization data associated with a unified user profile, the system may determine that the unified user profile is associated with a threshold year to date spending of $500. Based on the unified user profile being associated with the threshold, the system may determine that the unified user profile is further associated with a “high spenders” segment. Additionally, or alternatively, based on a unified user profile, the system may determine that the unified user profile is associated with browsing the category of raincoats. Based on the unified user profile being associated with browsing the category of raincoats, the system may determine that the unified user profile is further associated with a “rain” segment. In some instances, the system may determine one or more real-time segments based on one or more rules, or policies. For example, a company may define a rule indicating a particular segment of interest. Based on the segment, the system may be configured to update the relevant real-time data graph (e.g., unified real-time data graph) such that the personalization data associated with a unified user profile may be updated to indicate the segment for the unified user profile.

As described above, the system may be configured to perform one or more transformations, or processes, such as determining real-time unifications on profiles (e.g., identity resolution), real-time aggregation metrics (e.g., calculated insights), real-time segments (e.g., segmentation), etc. In some instances, the transformations may be performed independently (e.g., determining real-time metrics may be performed without determining real-time unifications). Additionally, or alternatively, in instances where multiple transformations are performed by the system, the system may be configured to determine the order in which the one or more transformations are executed. For example, the system may determine the order in which the one or more transformations are executed based on definitions associated with a process for a real-time data graph. By way of example, and not limitation, a real-time segment may be defined by the lifetime value (LTV) of the customer. As such, the system may determine that calculated insights for a real-time data graph must be performed before segmentation such that an LTV may be determined.

Additionally, or alternatively, the system may be configured to enable affined processing of user data (e.g., an event). For example, as described above, the system may receive user data and may be configured to determine real-time unifications on profiles, such as unifying an unknown user profile to a known user profile to generate a unified user profile and unified real-time data graph. When user profiles are unified (e.g., an identity is resolved), such resolution may be associated with a particular processing unit. For example, the processing of user data for real-time unifications on profiles may be directed, or routed, to a particular pod.

In some instances, the system may be configured to cause one or more subsequent transformations (e.g., calculated insights) to be performed by the same processing unit. For example, the system may use, or work in combination with, a routing component to route subsequent processing to the same processing unit at which the processing for real-time unifications on profiles was directed. This way, any changes and/or computations associated with a real-time data graph (e.g., a unified real-time data graph) may be run by the same processing unit, pod, etc. In other words, all processing (e.g., transformations) of the system and belonging to the same identity and/or resolved identities (e.g., a unified real-time data graph) may be run by the same processing unit so as to avoid a race condition, processing on stale data, etc. In some instances, the system may use, or work in combination with, the routing component, to route traffic associated with one or more transformations of user data to a processing unit via header-based routing. By way of example, and not limitation, the routing component may be configured to set, or embed, a header to include an indication of a real-time unification on a profile (e.g., a resolved identity) associated with the incoming user data. The embedded header may be used by the routing component to route subsequent user data transformations to the same processing unit. In instances where user data processing is routed to the same processing unit, the risk of conflicts or discrepancies in a real-time data graph may be reduced. Additionally, or alternatively, data from a real-time data graph may also be retrieved from the same processing unit.

The real-time personalization data may be usable, by the system and/or a third-party system, to generate an output. For example, an output may include a personalization at a web application, mobile application, etc. In some instances, the output may include a personalization at an application such as personalized text, decoration, user interface components, and/or the like. Additionally, or alternatively, the output may include a personalized communication. For example, a personalized communication may include an email, Short Message Service (SMS) message, and/or push notification. A personalized communication may include a personalized offer (e.g., discount), personalized reminder, etc. By way of example, as described above, real-time personalization data associated with a unified user profile may indicate a user's first browsing, such as browsing train times on a user's web browser. Real-time personalization data associated with a unified user profile may also indicate the user's second browsing, such as subsequently browsing train times on the user's mobile device. Using the techniques described herein, the system may use the real-time personalization data to generate an output. For example, the output may include displaying the same information from the user's web browser on the user's mobile device. In another example, as described above, real-time personalization data associated with a unified user profile may indicate that is part of a rain segment. Based on the real-time personalization data, the system may generate an output such as a discount to be displayed at a web browser for unified user profiles included in the rain segment.

An output may be generated, displayed, and/or sent at a particular time. For example, the output may be generated at a time that may be considered real time (e.g., within 500 milliseconds from the time of the user action). Additionally, or alternatively, the output may be generated, displayed, and/or sent based on one or more triggers. For example, a trigger may include the termination of a user session. The termination of a user session may be the termination of a user event (e.g., end of a user action). By way of example, and not limitation, the termination of a user session may be based on a user disengagement (e.g., a user exists a browser), timeout restrictions (e.g., a lack of activity after a threshold period of time), and/or the like.

Additionally, or alternatively, the user data received by the system (e.g., via an SDK) may also be sent to a storage layer. The storage layer may include one or more data graphs. As described above, a data graph may include a hierarchical view of objects in a data cloud, and may be defined by a primary DMO as well as one or more fields, related DMOs, etc. When user data is received by the storage layer, the system may be configured to generate and/or update one or more data graphs of the storage layer. A data graph of the storage layer may be a denormalized instance of a data graph (e.g., denormalized JSON structure), and corresponding to the real-time data graph of the real-time layer. In other words, the storage layer and the real-time layer may each have an instance of the same data graph. While the storage layer may receive the same user data as the real-time layer, the storage layer may not be configured to process the user data, update the data graph, and generate personalization data in real-time. For example, the storage layer may use an instance of a data graph in order to optimize data consistency and reduce redundancy, as opposed to optimizing real-time querying. As such, the storage layer may not process the user data, update the data graph, and generate personalization data in real-time.

In some instances, the storage layer may be configured to receive additional user data and/or user data from other sources. For example, while the real-time layer may receive user data of an action such as website purchase activity, the storage layer may receive user data of an action such as a user purchasing an item in-person at a store, returning an item at the store, and/or the like. Additionally, or alternatively, while user data may be received from sources such as web sources, mobile sources, CRM sources, etc., the real-time layer may receive user data from a subset of the data sources, whereas the storage layer may receive user data from all of the sources. Additionally, or alternatively, the storage layer may be configured to perform one or more transformations, such as those described above with respect to the real-time layer (e.g., identity resolution, calculated insights, and/or segmentation) using the same user data, additional user data, and/or user data from other sources. Based on the updated data graph, the system may be configured to generate personalization data.

As described above, a real-time data graph and data graph may be associated with (e.g., represented by) a denormalized JSON structure, or JSON object. Additionally, or alternatively, the system may be configured to determine the order in which one or more transformations are executed based on definitions associated with a process for a real-time data graph and/or data graph. In some instances, a data graph may be associated with process definitions for one or more transformations (e.g., calculated insights, segmentation, etc.) on the representative JSON object. Additionally, or alternatively, the order, or sequence, of transformations on the JSON object may be defined by an Application Runtime Object (ARO). By way of example, and not limitation, the sequence of transformations on the JSON object of the storage layer may be translated to an ARO definition. The ARO definition may then be executed by the real-time layer. This way, any new process type or process definitions of the storage layer may be extended to the real-time layer, where the real-time layer may compile and optimize the ARO for real-time processes (e.g., transformations).

In some instances, the personalization data of the storage layer may replace the real-time personalization data of the real-time layer (e.g., the updated data graph may replace the updated real-time data graph). In other words, the personalization data of the storage layer may be considered the single source of truth. For example, the data graph of the storage layer and related personalization data may replace the real-time data graph and related real-time personalization data after the termination of a session (e.g., after the need for real-time response). This way, an updated data graph determined by the storage layer may be a final source of truth, where subsequent real-time processing by the real-time layer may be based on the updated data graph being accessed through the real-time layer with low latency. Additionally, or alternatively, the personalization data may be usable by the system and/or third-party system to generate the output described above and/or update the output.

As illustrated by these examples, the techniques described herein can improve the functioning, efficiency, and overall user experience during application engagement and/or use. That is, the techniques described herein may enable the system to use a real-time layer to quickly update a real-time data graph and generate real-time personalization data. Further, the techniques may result in increased processing speeds for generating outputs that benefit from real-time presentation. The techniques also enable relational efficiencies and data accuracy by enabling the system to use the storage layer and related components in conjunction with the real-time layer, rather than operating real-time applications on different data models than non-real-time applications.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized, and changes can be made without departing from the scope of the disclosure. The following detailed description is, therefore, not to be taken in a limiting sense. The scope of the disclosure is defined only by the appended claims, along with the full scope of equivalents to which such claims are entitled.

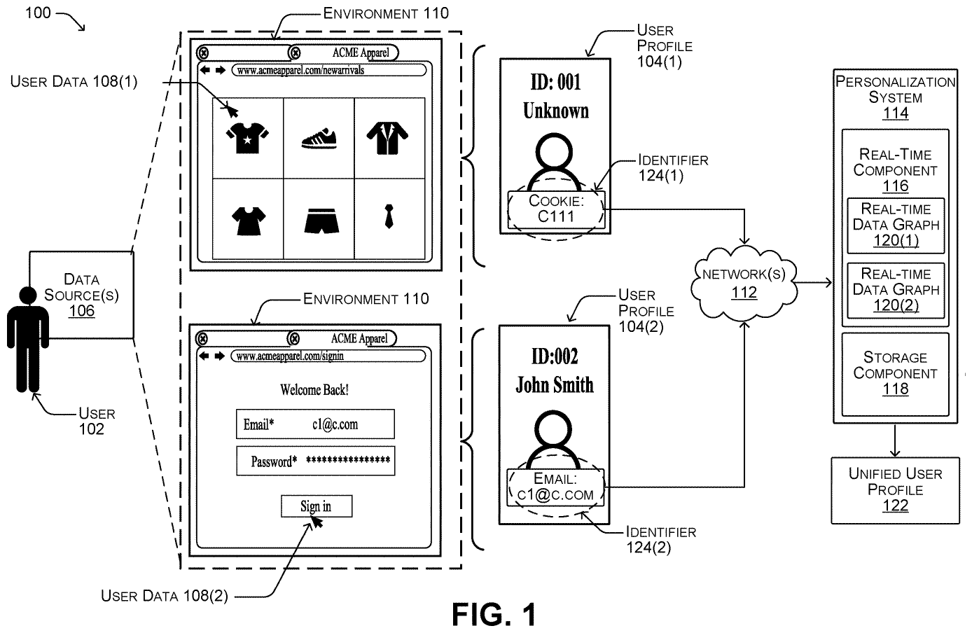

FIG. 1 illustrates a schematic view of an example system 100 for data processing for real-time data graphs and personalization.

In some examples, a personalization system 114 may be supported by a data cloud service, or platform, including computing servers, data centers, and/or a cloud computing network. A data cloud service may be, or comprise, a data cloud provider network (e.g., a service provider network). The service provider network may be or comprise a cloud provider network. A cloud provider network (sometimes referred to simply as a “data cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network may be an on-premises network, a private network of a corporation, and/or any other type of network or combination thereof.

The personalization system 114 may include one or more components configured to store and/or analyze data, such as real-time component 116 and storage component 118 (e.g., a storage layer). Additionally, or alternatively, the personalization system 114 may be, or comprise, a service provider offering different built-in services to customers, users, etc. to help run their applications and services. For example, the personalization system 114 may include built-in services for computer applications such as a browser, application programming interface (API), software development kit (SDK), and/or the like.

The personalization system 114 may receive user data 108. The user data 108 may be, or comprise, an action from a user 102 at an environment 110, such as a user interface associated with a web application, mobile application, and/or the like. Additionally, or alternatively, the user data 108 may be received from data source(s) 106 such as web sources, mobile sources, CRM sources, etc. By way of example, and not limitation, a user action may include an engagement and/or interaction with an application, or environment 110 (e.g., a user browsing a website, clicking on a product, logging in, etc.). In some instances, the environment 110 may be associated with one or more user devices. User devices may include one or more of different personal user devices, such as desktop computers, laptop computers, phones, tablets, wearable devices, entertainment devices such as televisions, and/or any other type of computing device. The environment 110 may be communicatively coupled with the personalization system 114 via network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 112 may include devices, virtual resources, or other nodes that relay packets from one device to another.

In some instances, the user data 108 received by the personalization system 114 (e.g., via an SDK) may be sent to the real-time component 116. By way of example, and not limitation, the real-time component 116 may receive user data 108 corresponding to a user action (e.g., engagement) with a website. Based on the user action, a real-time data graph 120 of the real-time component 116 may be generated and/or updated. For example, user data 108(1) may include a user 102 browsing a website anonymously. Based on the user data 108(1), the real-time component 116 may determine whether the user data 108(1) is associated with a known or unknown user profile 104. In other words, based on the user data 108(1), the real-time component 116 may determine whether a real-time data graph (e.g., a Profile real-time data graph) already exists. For example, user data 108 may be associated with one or more identifiers 124. An identifier 124 may be a Hypertext Transfer Protocol (HTTP) cookie identifier, a device identifier, an authentication identifier, an email identifier, and/or the like. By way of example, and not limitation, user data 108(1) may be associated with an unknown user because the user data 108(1) includes a user action such as anonymous browsing (e.g., no authentication, PII data, user-generated identifier, and/or the like). Instead, the user data 108(1) may only be associated with a cookie identifier (e.g., C111). As such, the personalization system 114 may be configured to generate a new real-time data graph (e.g., a Profile real-time data graph), such as real-time data graph 120(1). The real-time data graph 120(1) may be usable to determine real-time personalization data, and in turn, an unknown user profile 104(1). As illustrated, the unknown user profile 104(1) may include a profile ID (e.g., ID: 001) and an indication of the cookie identifier 124(1).

In another example, user data 108(2) may include the user 102 browsing a website, where the user may subsequently sign in with an email. Based on the user data 108(2), the real-time component 116 may determine whether the user data 108(2) is associated with a known or unknown user profile 104. In other words, based on the user data 108(2), the real-time component 116 may determine whether a real-time data graph (e.g., a Profile real-time data graph) already exists. As described above, user data 108 may be associated with one or more identifiers 124. An identifier 124 may be a Hypertext Transfer Protocol (HTTP) cookie identifier, a device identifier, an authentication identifier, an email identifier, and/or the like. By way of example, and not limitation, user data 108(2) may be associated with a known user because the user data 108(2) includes a user action including an authentication using an email identifier (e.g., identifier 124(2)). As such, the personalization system 114 may be configured to update an existing real-time data graph (e.g., a Profile real-time data graph), such as real-time data graph 120(2), associated with a known user profile 104(2), to include data associated with real-time data graph 120(1). The real-time data graph 120(2) may be usable to determine real-time personalization data, and in turn, a known user profile 104(2). As illustrated, the known user profile 104(2) may include a profile ID (e.g., ID: 002), PII data (e.g., John Smith), and/or email identifier 124(2).

In some instances, when user data 108 is received by the real-time component 116, the personalization system 114 may be configured to perform one or more transformations associated with one or more real-time data graphs 120 (e.g., generating a unified data graph for a unified user profile 122). For example, the personalization system 114 may be configured to unify user profiles 104 such that known and/or unknown user profiles 104 may be connected (e.g., identity resolution) and a unified user profile 122 may be generated. In some instances, the personalization system 114 may be configured to connect user profiles 104, and generate a unified data graph for a unified user profile 122. For example, the personalization system 114 may determine that the unknown user profile 104(1) corresponds to the known user profile 104(2) based on the user data 108(2) of the subsequent email sign in. Based on the unknown user profile 104(1) corresponding to the known user profile 104(2), the personalization system 114 may generate a unified real-time data graph that may indicate personalization data for a unified user profile 122. For example, the unified user profile 122 may include an indication of the cookie identifier (e.g., C111), email (e.g., c1@c.com), and/or PII data (e.g., John Smith). This way, an unknown user profile 104(1) and known user profile 104(2) may be unified for a single user 102. In other words, the unified real-time data graph for the unified user profile 122 may include an indication of both the actions associated with the user data 108(1) when the user profile 104(1) was unknown, as well as other data associated with the known user profile 104(2) (e.g., previous browsing patterns associated with the known user profile 104(2)).

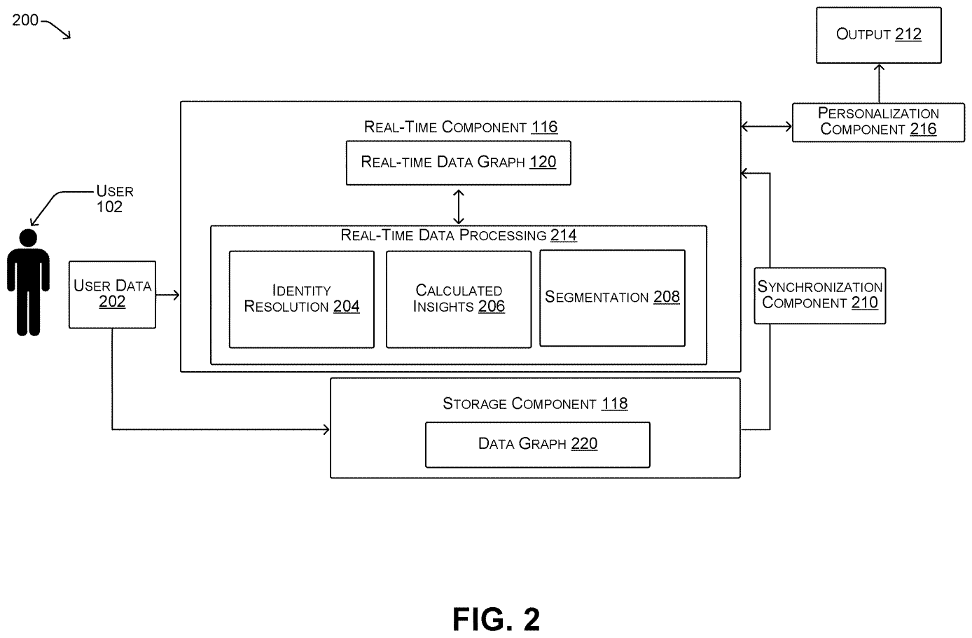

FIG. 2 illustrates a system-architecture diagram of an example system 200 in which a system uses real-time data graphs.

The system 200 may include one or more components configured to store and/or analyze data (e.g., a data warehouse, data lake, etc.). For example, the system 200 may include one or more storage layers and/or platforms. The system may include a storage layer (e.g., a data warehouse, data lake, and/or a combination thereof (“a data lakehouse”)) and a low-latency storage layer (which may be referred to as a “a real-time layer”). For example, the storage layer may correspond to storage component 118, and the low-latency storage layer may correspond to real-time component 116.

As illustrated, user data 202 from a user 102 may be received by the system, and at the real-time component 116 and the storage component 118. The real-time component 116 may include one or more denormalized data graphs (e.g., real-time data graph 120). As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

When user data 202 is received by the real-time layer, the system may be configured to generate and/or update one or more real-time data graphs, such as real-time data graph 120. Before the user data 202 is updated into the real-time data graph 120, the real-time component 116 may be configured to process and/or apply one or more transformations to the user data 202. For example, real-time processing 214 may include identity resolution 204, calculated insights 206, and/or segmentation 208. Identity resolution 204 may be configured to unify user data (e.g., data at different devices, but from the same user). For example, based on the user data 202, identity resolution 204 may match different user identities, or user profiles, into a unified identity (e.g., unified data graph). Identity resolution 204 may be based on one or more rules. For example, user identities may be unified if there is a match between user emails. Calculated insights 206 may be configured to perform one or more computations with respect to the user data 202, such as aggregating and/or counting metrics. For example, calculated insights 206 may be configured to determine an aggregation of all browsing performed by the user 102, total spending (e.g., LTV) of the user 102, and/or the like. Aggregations by calculated insights 206 may be available in real time and reflected in the real-time data graph 120. Segmentation 208 may be configured to classify, or segment, a user 102. For example, an organization may define one or more segments on the real-time data graph 120. A segment may be based on any element of the data graph 120 (e.g., a segment based on browsing behavior, product purchasing, etc.) and/or aggregations by calculated insights 206 (e.g., a segment based on total spending of the user 102). One or more segments associated with a user 102 and determined by segmentation 208 may be available in real time and reflected in the updated real-time data graph 120. Subsequent to real-time data processing 214, and based on an updated real-time data graph 120, the real-time component 116 may be configured to generate real-time personalization data. The real-time personalization data may be usable by a personalization component 216 to generate an output 212.

As described above, the user data 202 may also be received by the storage component 118. The storage component 118 may include one or more data graphs. A data graph may be a denormalized instance of a data graph (e.g., denormalized JSON structure), and corresponding to the real-time data graph 120 of the real-time component 116. In some instances, the storage component 118 may be configured to receive additional user data and/or user data from other sources. Additionally, or alternatively, while user data 202 may be received from sources such as web sources, mobile sources, CRM sources, etc., the real-time component 116 may receive user data from a subset of the data sources, whereas the storage component 118 may receive user data from all of the sources. Before user data 202 is updated into the data graph, the storage component 118 may be configured to apply one or more transformations to the user data 202. While not illustrated, the storage component 118 may similarly perform processing such as identity resolution 204, calculated insights 206, and/or segmentation 208. Once user data 202 has been updated into the data graph, the updated data graph may be used by the storage component to generate personalization data. For example, the personalization data may comprise a user profile that has been updated based on user data 202 received by both the real-time component 116 and the storage component 118, and/or additional data received by the storage layer.

In some instances, a synchronization component 210 of the system 200 may be configured to replace the real-time personalization data of the real-time component 116 with the personalization data of the storage component 118 (e.g., the updated data graph may replace the real-time data graph 120). In other words, the personalization data of the storage component 118 may be considered the single source of truth. For example, the data graph of the storage component 118 and related personalization data may replace the real-time data graph 120 and related real-time personalization data after the termination of a session (e.g., after the need for real-time response). This way, subsequent real-time processing 214 by the real-time component 116 may be based on the updated data graph determined by the storage component 118, as opposed to the updated real-time data graph 120 previously-determined by the real-time component 116. Additionally, or alternatively, the personalization data may be usable by the personalization component 216 to generate the output 212 described above and/or update the output 212.

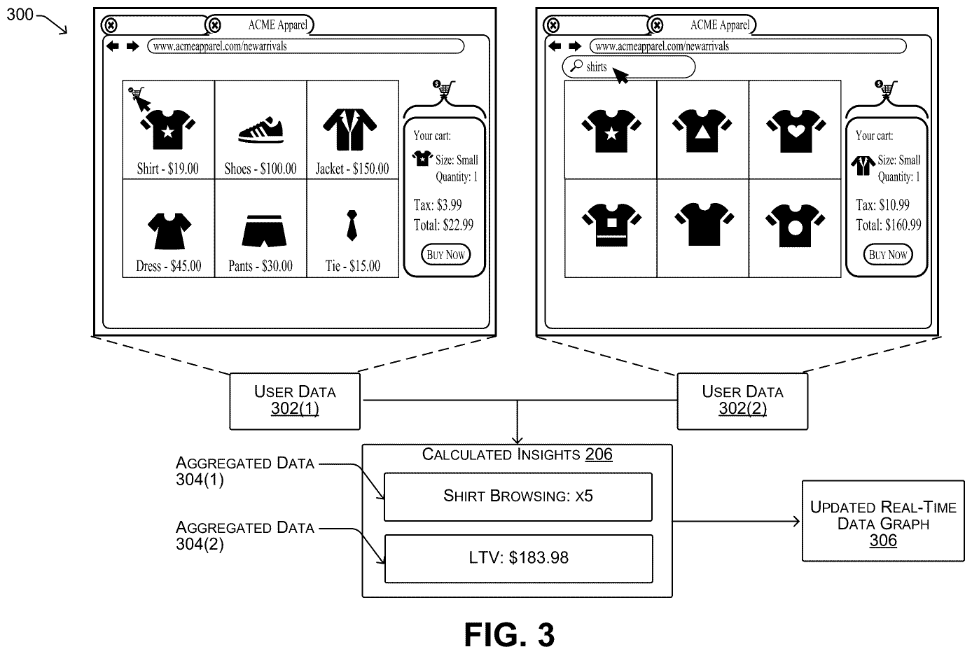

FIG. 3 illustrates a block diagram including an example process 300 for real-time computations on user data for real-time data graphs.

For example, when user data, such as user data 302 is received by a real-time component (e.g., real-time component 116), the personalization system 114 may be configured to perform one or more transformations, such as determining one or more metrics (e.g., aggregated data 304) comprising calculated insights 206. For example, user data 302(1) at a first time may indicate a user's first actions, where an associated real-time data graph may be generated and/or updated based on the first actions. By way of example, and not limitation, user data 302(1) may include a user browsing a retailer website, and adding an item to a virtual shopping cart of the retailer website for purchase (e.g., for a total of $22.99). User data 302(2) at a second time may indicate a user's second actions, where an associated real-time data graph may be generated and/or updated based on the first actions. By way of example, and not limitation, user data 302(1) may include the user browsing the retailer website further (e.g., for more shirts), and adding an additional item to the virtual shopping cart of the retailer website for purchase (e.g., for a total of $160.99). In some instances, the user data 302(1) may be used to update a first real-time data graph, where the user data 302(2) may be used to update a second real-time data graph. In such an instance, as described above with respect to FIG. 1, the personalization system 114 may be configured to merge the first and second real-time data graph to generate a unified real-time data graph for a unified user profile (e.g., merging an unknown to known profile, merging two unknown profiles, etc.). Additionally, or alternatively, the personalization system 114 may perform one or more calculated insights 206, such as aggregating user data 302(1) and user data 302(2). For example, the personalization system 114 may generate real-time aggregated data, the real-time aggregated data indicating the user's total browsing, lifetime value (LTV) of spending, and/or the like. As illustrated, aggregated data 304(1) may indicate that a user has browsed for shirts a total of five times. Additionally, or alternatively, aggregated data 304(2) may indicate that the user has an LTV for spending of $183.98.

The real-time aggregated data 304 may be used by the personalization system 114 to update the relevant real-time data graph (e.g., the unified real-time data graph), such as to generate an updated real-time data graph 306. In some examples, the real-time aggregated data 304 may comprise real-time personalization data for a user profile (e.g., unified user profile).

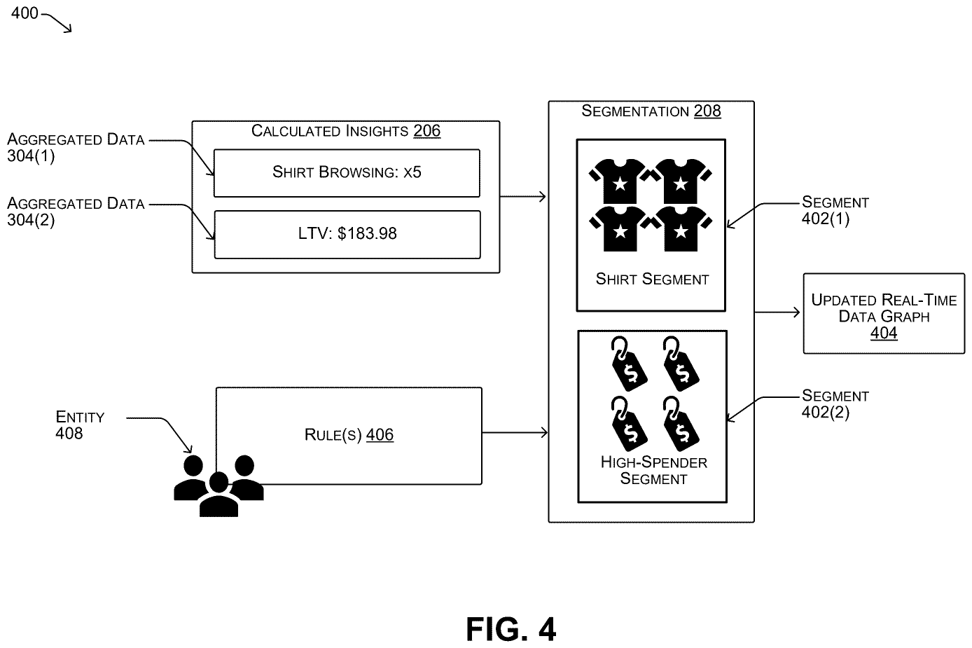

FIG. 4 illustrates a block diagram including an example process 400 for user segmentation for real-time data graphs.

For example, the personalization system 114 may be configured to perform segmentation 208 such that one or more user profiles may be associated with one or more segments in real time. For example, a real-time segment 402 may be determined for an identified unified profile. A real-time segment 402 may be based on personalization data associated with a unified user profile. Additionally, or alternatively, a real-time segment 402 may be determined based on a unified user profile including a data 304. As described above with respect to FIG. 3, the personalization system 114 may generate real-time aggregated data, the real-time aggregation data indicating the user's total browsing, lifetime value (LTV) of spending, and/or the like. As illustrated, aggregated data 304(1) may indicate that a user has browsed for shirts a total of five times. Additionally, or alternatively, aggregated data 304(2) may indicate that the user has an LTV for spending of $183.98.

A real-time segment 402 may indicate a particular category, threshold, attribute, and/or the like. A real-time segment 402 may be associated with a particular product (shirt, raincoat, boots, sneakers, etc.), a particular financial value, a particular temporal value, etc. By way of example, and not limitation, based on real-time personalization data associated with a unified user profile, the system may determine that the unified user profile meets or exceeds a threshold LTV spending value. For example, based on the aggregated data 304(1), the personalization system may determine that the unified user profile is associated with a “shirt” segment 402(1) based on the aggregated data 304(1) meeting a threshold (e.g., user profiles associated with browsing shirts at least five times may be determined as being part of the shirt segment 402(1). Additionally, or alternatively, based on aggregated data 304(2), the personalization system may determine that the unified user profile is further associated with a “high-spender” segment 402(2) based on the aggregated data 304(2) being above a threshold (e.g., user profiles associated with a LTV spending value above a threshold of $150 may be determined as being a part of the higher spender segment 402(2). Based on the determined segments 402, the personalization system 114 may update an associated real-time data graph to generate an updated real-time data graph 404 to reflect the segment 402, and in turn, update the unified user profile.

In some instances, the personalization system 114 may determine segments 402 based on one or more rules 406. For example, an entity 408 (e.g., enterprise, corporation, company, retailer, and/or the like) may define a rule indicating a particular segment of interest. For example, the entity 408 may define a rule 406 indicating that user profiles associated with browsing shirts at least five times are to belong in the shirt segment 402(1). Additionally, or alternatively, the entity 408 may define a rule 406 indicating that user profiles associated with spending more than $150 are to belong in the high-spender segment 402(2).

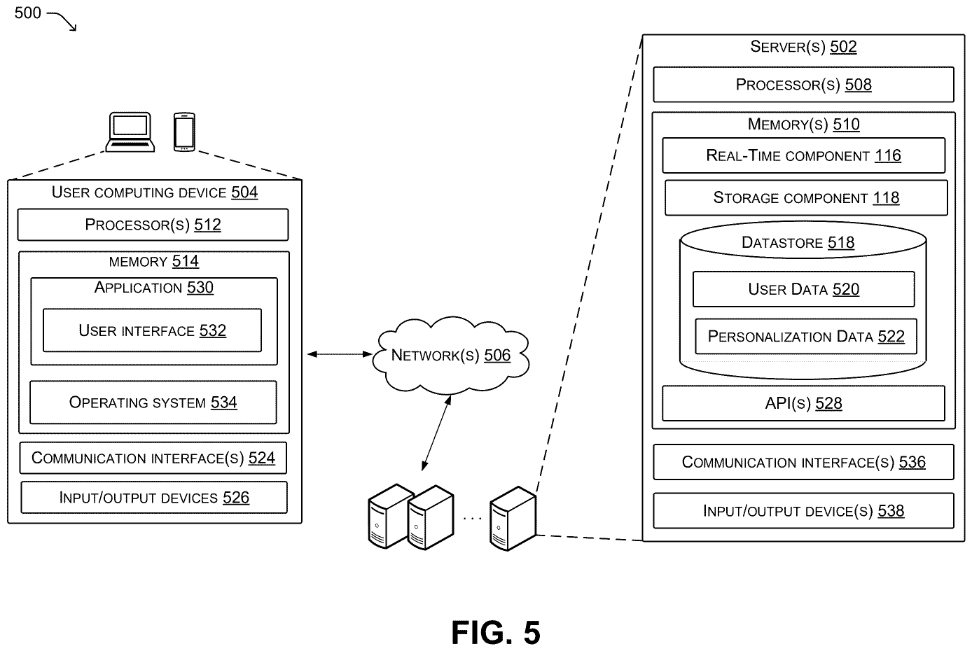

FIG. 5 illustrates an example environment 500 for performing the techniques described herein. The techniques discussed herein may be used in a variety of environments and for a variety of uses, although the examples given herein discuss a customer service environment as one of these use cases since it's a use case familiar to many. In additional or alternate examples, the computing environment may comprise computing devices used for sales-based systems, communication platforms, chat engines, cybersecurity, search engines, multi-agent/agentic machine-learned model pipeline(s) and/or cluster(s), machine-learned model training, cloud/distributed computing or massive computing efficient data storage and/or retrieval, and/or the like.

The techniques described herein may include a machine-learned model. In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage m

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In at least one example, the example environment 500 may include one or more computing devices, such as server(s) 502 and/or a user computing device(s) 504. By way of example and not limitation, the server(s) 502 may be representative of servers for hosting the software, hardware, containers, and/or the like to implement at least part of the techniques discussed herein. For example, the server(s) 502 may host (e.g., store and/or execute) system software. The user computing device(s) 504 may be representative of user computing device(s) associated with a first user (i.e., a first “client device”).

The server(s) 502 may comprise one or more individual servers or other computing devices that may be physically located in a single central location or may be distributed at multiple different locations. The server(s) 502 communication may be hosted privately by an entity administering all or part of the environment 500 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures may be used. Moreover, the server(s) 502 may comprise hardware and/or software containers accessible to different tenants with access to the server(s) 502.

The user computing device(s) 504 may be any suitable type of computing device, e.g., portable, semi-portable, semi-stationary, or stationary. Some examples of the user computing device(s) 504 may include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the user computing device(s) 504 may comprise distributed computing devices, server(s), etc.

In some examples, the server(s) 502 and/or user computing device(s) 504 may be configured to transmit network packages therebetween via network(s) 506. The network(s) 506 may include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network,, or any other such network, or any combination thereof. The network(s) 506 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the user computing device(s) 504 may transmit a request to and/receive an output from the server(s) 502 via the communication platform. Components used for such communications can depend at least in part upon the type of network, the environment selected, or both. Further, the network(s) 506 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

The server(s) 502 and the user computing device(s) 504 described herein may include one or more processors and/or memory. Specifically, in the illustrated example, server(s) 502 may include processor(s) 508 and memory 510 and user computing device(s) 504 include processor(s) 512 and memory 514.

By way of example and not limitation, the processor(s) 508 and/or 512 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions. For example, the processor(s) 508 and/or 512 can be one or more hardware processors and/or logic circuits of any suitable type specifically programmed or configured to execute the algorithms and processes described herein. The processor(s) 508 and/or 512 can be configured to fetch and execute computer-readable instructions stored in the computer-readable media, which can program the processor(s) to perform the functions described herein.

The memory 510 and/or 514 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 510 and/or 514 can be used to store any number of software/functional components that are executable by the processor(s) 508 and/or 512, respectively. In many implementations, these functional components comprise instructions or programs that are executable by the processor(s) 508 and/or 512 and that, when executed, specifically configure the processor(s) 508 and/or 512 to perform the actions server(s) 502 and/or user computing device(s) 504, according to the discussion herein.

For example, server(s) 502 may comprise a memory 510 storing the real-time component 116 and storage component 118. As described throughout, the real-time component 116 and/or storage component 118 may leverage data graphs to determine real-time personalization data, respectively. In some examples, the system may receive user data including a user action (e.g., browsing a webpage, clicking a user interface component, etc.). The system may leverage the real-time component 116 such that a real-time data graph may be generated and/or updated based on the user action. Accordingly, the system may use the real-time data graph to generate personalization data. When generating personalization data, the real-time component 116 may update and/or create a user profile, where the user profile may indicate attributes, actions, and/or the like associated with a user. The real-time component 116 may determine personalization data at a time at which the personalization data may be accessed and/or used in real-time. The system may also leverage the storage component 118, where the storage component 118 may include a data graph. The storage layer may also receive the user data, and/or other data. The system may leverage the storage component 118 such that a data graph may be generated and/or updated based on the user action and/or other actions (e.g., non-real-time actions). The system may use the data graph to also generate personalization data. For example, the personalization data generated using the data graph of the storage component 118 may be used by the system to further update the user profile. The personalization data generated using the data graph of the storage component 118 may be determined at a time at which the personalization data may be accessed and/or used at a subsequent time (e.g., not real-time). Additionally, or alternatively, personalization data may be used to generate one or more personalized outputs for a user.

Additionally, or alternatively, the memory 510 may comprise a portion of memory 510 (e.g., one or more memories or a portion of a single memory) that collectively forms a datastore 518 (e.g., a database). In some examples, the datastore 518 can be integrated with the server(s) 502, as shown in FIG. 4. In other examples, the datastore 518 can be located remotely from the server(s) 502 and can be accessible to the server(s) 502 and/or user device(s), such as the user computing device(s) 504. The datastore 518 can comprise multiple databases, which may include user data 520 and/or personalization data 522. Additional or alternative data may be stored in the data store and/or one or more other data stores.

In at least one example, the user data 520 may correspond to user data 108, 202, and/or user data 302. As described above, the user data 520 may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data 520 may be location data, voice data, financial data, and/or the like. For example, the user data 520 may be, or comprise, a user action such as breaking a geofence, walking into a movie theatre, etc.

In at least one example, personalization data 522 may include a user profile that has been updated in real-time, at a time subsequent to a user session, etc. For example, based on the updated real-time data graph, personalization data 522 may include an indication of previous context (e.g., the email address of the user) and the current (e.g., real-time) user data (e.g., adding the item to a shopping cart). Personalization data 522 may include related attributes, or properties, of an individual (e.g., the user), an account, etc. associated with a user profile.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

Additionally, or alternatively, the memory 510 may store application programming interface(s) (API(s) 528), hypervisor(s), container orchestration system(s), an operating system, and/or container (unillustrated). The API(s) 528 may expose back-end functions and/or services hosted by the server(s) 502 to the user computing device(s) 504 and/or different component(s) hosted by the server(s) 502 without transferring the functions/services/software to those computing device(s) and/or by accomplishing the functions and/or services at the server(s) 502. As relates to the instant discussion, this may comprise API(s) for receiving indications from a user (e.g., as part of an API call), or from different ones of the components.

In some examples, software executed at the user computing device(s) 504, such as a client application 530, may generate API call(s) to the API(s) 528 and/or any of the component(s) discussed herein may transmit call(s) to the API(s) 528 and/or receive responses from the API(s) 528. For example, a user interface 532 executed by a client application 530 may display actuatable/selectable options to request that the client application 530 perform an action. In some examples, the client application 530 may interface with the API(s) 528 to authenticate a user and grant or deny the user access to a portion of the datastore 518, real-time component 116, and/or storage component 118.

Additionally, or alternatively, the memory 510 may comprise an operating system and/or container. In some examples, one or more containers may be instantiated by a cloud orchestrator and may run the operating system and may execute one or more instances of the API(s) 528, real-time component 116, and/or storage component 118, and may permit access to a portion of the datastore 518 according to permissions associated with a user and an organization associated with the container.

In some examples, the server(s) 502 may further comprise communication interface(s) 536, which may include one or more interfaces and hardware components for enabling communication with various other devices (e.g., the user computing device(s) 504), such as over the network(s) 506 or directly. In some examples, the communication interface(s) 536 can facilitate communication via WebSockets, APIs (e.g., using API calls), Hypertext Transfer Protocols (HTTPs), etc. The server(s) 502 can further be equipped with various input/output devices 538 (e.g., I/O devices). Such input/output devices 538 may include a display, various user interface controls (e.g., buttons, joystick, keyboard, mouse, touch screen, etc.), audio speakers, connection ports, and so forth.

In at least one example, the user computing device(s) 504 may include processor(s) 512, memory 514, communication interface(s) 524, and/or input/output device(s) 526. The memory 510 may store and execute a client application 530 and/or an operating system 534. In some examples, the client application 530 may be configured to authenticate a user to access data and/or services hosted by the server(s) 502. The API(s) 528 may filter the users and/or orgs accessible depending on permissions granted to a type of user profile and/or an organization associated with the user. In at least one example, a user profile to which a user authenticates may include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like, as described above.

In some examples, the client application 530 may comprise instructions executable by one or more processors to provide a user interface 532. For example, the user interface 532 may comprise a graphical user interface (GUI), that the instructions may cause to be displayed via at least one of the input/output device(s) 526. In at least one example, the client application 530 can be a mobile application, a web application, a database interface (e.g., such as an application that presents a SQL or other database interface), or a desktop application. For example, a computing device of the one or more user computing device(s) 504 may access the API(s) 528 via a web browser or stand-alone application (either of which may be part of or host the client application 530) that communicates via network(s) 506 with API(s) 528.

In at least one example, the operating system 534 can manage the processor(s) 508, memory 510, hardware, software, etc. of the server(s) 502.

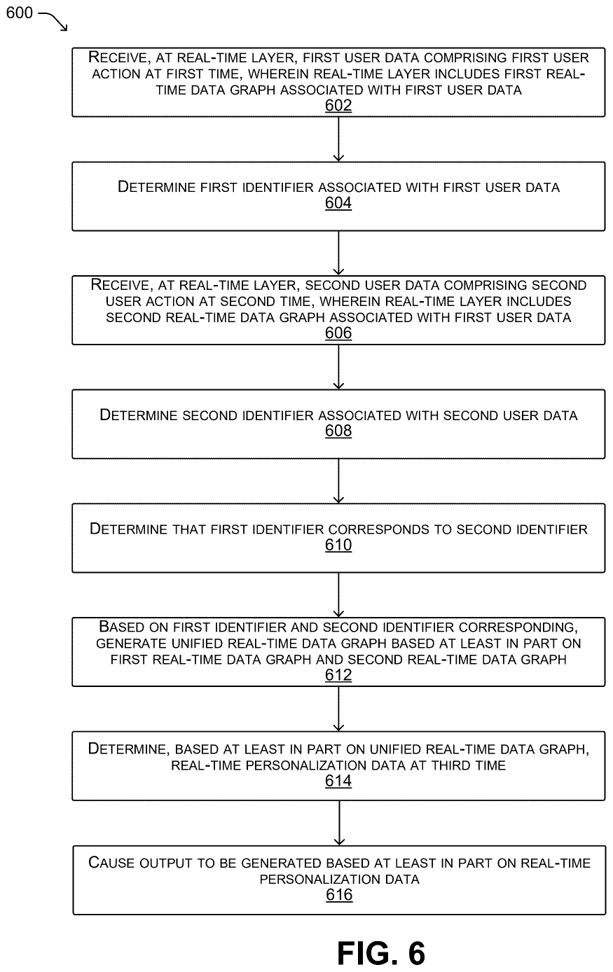

FIG. 6 is a flow diagram illustrating an example process of data processing using real-time data graphs for personalization. The processes illustrated in FIG. 6 are described with reference to components described above with reference to FIGS. 1-5 for convenience and ease of understanding. However, the processes illustrated in FIG. 6 are not limited to being performed using the components described above. Moreover, the components described above are not limited to performing the processes illustrated in FIG. 6.

Process 600 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 602, the process 600 may include receiving, at a real-time layer, first user data comprising a first user action at a first time, wherein the real-time layer includes a first real-time data graph associated with the first user data. For example, the user data may be received by an SDK associated with the system. The user data may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data may be location data, voice data, financial data, and/or the like. For example, the user data may be, or comprise, a user action such as breaking a geofence, walking into a movie theatre, etc.

In some instances, the user data received by the system (e.g., via an SDK) may be sent to the real-time layer. The real-time layer may include one or more denormalized data graphs (hereinafter “real-time data graph”). A real-time data graph may correspond to a data graph of a storage layer that is accessed through the real-time layer with low latency. As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

By way of example, and not limitation, the real-time layer may receive user data corresponding to a user action (e.g., engagement) with a website. Based on the user action, a real-time data graph of the real-time layer may be updated. Based on the updated real-time data graph, the system may be configured to generate real-time personalization data. For example, real-time personalization data may comprise a user profile that has been updated in real-time. Based on the updated real-time data graph, the real-time personalization data may include an indication of previous context and the current (e.g., real-time) user data. Accordingly, based on the real-time personalization data, a user profile may include related attributes, or properties, of an individual (e.g., the user), an account, etc.

At operation 604, the process 600 may include determining a first identifier associated with the first user data. For example, user data may comprise a user action at a web application, mobile application, and/or the like. Additionally, or alternatively, user data may indicate an identifier. An identifier may be a Hypertext Transfer Protocol (HTTP) cookie identifier, a device identifier, an authentication identifier, an email identifier, and/or the like. In some instances, an identifier may be associated with a known identity (e.g., known user profile). For example, an identifier may be associated with a known identity if the identifier has previously undergone authentication, is associated with Personally Identifiable Information (PII) data (e.g., phone number, name, email, etc.), is associated with a user-generated identifier, and/or the like. By way of example, and not limitation, user data may include a user action such as browsing at a web application, where the user may sign-in with an email identifier.

Additionally, or alternatively, an identifier may be associated with an unknown identity (e.g., unknown user profile). For example, an identifier may be associated with an unknown identity if the identifier has not previously undergone authentication, is not associated with PII data, is not associated with a user-generated identifier, and/or the like. By way of example, and not limitation, user data may include a user action such as browsing at a web application, but doing so anonymously. In such an example, the identifier may comprise a cookie identifier.

In some instances, upon receipt of user data including a user action such as browsing at a web application, where the user may sign in with an email identifier, the system may identify a known user profile based on the email identifier, and update the corresponding real-time data graph. For example, the system may update a real-time data graph defined by a Profile DMO such that the real-time data graph includes an indication of the user data and usable to generate real-time personalization data for a user profile. In some instances, the real-time data graph defined by the Profile DMO may also be associated with a new identification, or user profile. Additionally, or alternatively, upon receipt of user data including a user action such as browsing at a web application, where the user is doing so anonymously, the system may generate a real-time data graph including an indication of the cookie identifier, and in turn, an unknown user profile. For example, because the user is unknown, the system may generate a real-time data graph with a Profile DMO such that the real-time data graph includes an indication of the user data and usable to generate real-time personalization data for a user profile.

At operation 606, the process 600 may include receiving, at the real-time layer, second user data comprising a second user action at a second time, wherein the real-time layer includes a second real-time data graph associated with the second user data. For example, the user data may be received by an SDK associated with the system. The user data may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data may be location data, voice data, financial data, and/or the like. For example, the user data may be, or comprise, a user action such as breaking a geofence, walking into a movie theatre, etc.

In some instances, the user data received by the system (e.g., via an SDK) may be sent to the real-time layer. The real-time layer may include one or more denormalized data graphs (hereinafter “real-time data graph”). A real-time data graph may correspond to a data graph of a storage layer that is accessed through the real-time layer with low latency. As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

By way of example, and not limitation, the real-time layer may receive user data corresponding to a user action (e.g., engagement) with a website. Based on the user action, a real-time data graph of the real-time layer may be updated. Based on the updated real-time data graph, the system may be configured to generate real-time personalization data. For example, real-time personalization data may comprise a user profile that has been updated in real-time. Based on the updated real-time data graph, the real-time personalization data may include an indication of previous context and the current (e.g., real-time) user data. Accordingly, based on the real-time personalization data, a user profile may include related attributes, or properties, of an individual (e.g., the user), an account, etc.

At operation 608, the process 600 may include determining a second identifier associated with the second user data. For example, user data may comprise a user action at a web application, mobile application, and/or the like. Additionally, or alternatively, user data may indicate an identifier. An identifier may be a Hypertext Transfer Protocol (HTTP) cookie identifier, a device identifier, an authentication identifier, an email identifier, and/or the like. In some instances, an identifier may be associated with a known identity (e.g., known user profile). For example, an identifier may be associated with a known identity if the identifier has previously undergone authentication, is associated with Personally Identifiable Information (PII) data (e.g., phone number, name, email, etc.), is associated with a user-generated identifier, and/or the like. By way of example, and not limitation, user data may include a user action such as browsing at a web application, where the user may sign-in with an email identifier.

Additionally, or alternatively, an identifier may be associated with an unknown identity (e.g., unknown user profile). For example, an identifier may be associated with an unknown identity if the identifier has not previously undergone authentication, is not associated with PII data, is not associated with a user-generated identifier, and/or the like. By way of example, and not limitation, user data may include a user action such as browsing at a web application, but doing so anonymously. In such an example, the identifier may comprise a cookie identifier.

In some instances, upon receipt of user data including a user action such as browsing at a web application, where the user may sign in with an email identifier, the system may identify a known user profile based on the email identifier, and update the corresponding real-time data graph. For example, the system may update a real-time data graph defined by a Profile DMO such that the real-time data graph includes an indication of the user data and usable to generate real-time personalization data for a user profile. In some instances, the real-time data graph defined by the Profile DMO may also be associated with a new identification, or user profile. Additionally, or alternatively, upon receipt of user data including a user action such as browsing at a web application, where the user is doing so anonymously, the system may generate a real-time data graph including an indication of the cookie identifier, and in turn, an unknown user profile. For example, because the user is unknown, the system may generate a real-time data graph with a Profile DMO such that the real-time data graph includes an indication of the user data and usable to generate real-time personalization data for a user profile.

At operation 610, the process 600 may include determining that the first identifier corresponds to the second identifier. For example, as described above, the system may receive user data including an action of anonymous web browsing (e.g., first user data), and generate a real-time data graph associated with a cookie identifier (e.g., a first real-time data graph), where the first real-time data graph may indicate real-time personalization data for an unknown profile. The system may also receive second user data. For example, second user data may include an action of a sign-in using an email identifier at the same web application (e.g., subsequent to anonymous web browsing). The system may update a real-time data graph associated with the email identifier (e.g., a second real-time data graph), where the second real-time data graph may indicate real-time personalization data for a known profile. For example, the real-time personalization data for a known profile may include PII data such as a name, phone number, etc. Based on the first user data and the second user data, the system may determine that the unknown profile corresponds to the known profile.

At operation 612, the process 600 may include, based on the first identifier and the second identifier corresponding, generating a unified real-time data graph based at least in part on the first real-time data graph and the second real-time data graph.

At operation 614, the process 600 may include, based at least in part on the unified real-time data graph, determining real-time personalization data at a third time. For example, the system may be configured to connect identifiers, or user profiles, and generate a unified data graph. Continuing from the example above, based on the profiles corresponding, the system may generate a unified real-time data graph that may indicate personalization data for a unified profile. For example, the unified real-time data graph may include an indication of the cookie identifier, the email identifier, and/or PII data. This way, an unknown profile and known profile may be unified. In other words, the unified real-time data graph for the unified user profile may include an indication of both the actions associated with the first user data when the profile was unknown, as well as the user data during which the profile was known.

At operation 616, the process 600 may include causing an output to be generated based at least in part on the real-time personalization data. For example, the real-time personalization data may be usable, by the system and/or a third-party system, to generate an output. For example, an output may include a personalization at a web application, mobile application, etc. In some instances, the output may include a personalization at an application such as personalized text, decoration, user interface components, and/or the like. Additionally, or alternatively, the output may include a personalized communication. For example, a personalized communication may include an email, Short Message Service (SMS) message, and/or push notification. A personalized communication may include a personalized offer (e.g., discount), personalized reminder, etc. By way of example, as described above, real-time personalization data associated with a unified user profile may indicate a user's first browsing, such as browsing train times on a user's web browser. Real-time personalization data associated with a unified user profile may also indicate the user's second browsing, such as subsequently browsing train times on the user's mobile device. Using the techniques described herein, the system may use the real-time personalization data to generate an output. For example, the output may include displaying the same information from the user's web browser on the user's mobile device. In another example, as described above, real-time personalization data associated with a unified user profile may indicate that is part of a rain segment. Based on the real-time personalization data, the system may generate an output such as a discount to be displayed at a web browser for unified user profiles included in the rain segment.

An output may be generated, displayed, and/or sent at a particular time. For example, the output may be generated at a time that may be considered real time (e.g., within 500 milliseconds from the time of the user action). Additionally, or alternatively, the output may be generated, displayed, and/or sent based on one or more triggers. For example, a trigger may include the termination of a user session. The termination of a user session may be the termination of a user event (e.g., end of a user action). By way of example, and not limitation, the termination of a user session may be based on a user disengagement (e.g., a user exists a browser), timeout restrictions (e.g., a lack of activity after a threshold period of time), and/or the like.

### Example Clauses

A. A system comprising: one or more processors; and one or more non-transitory computer-readable media storing computer-executable instructions that, when executed, cause the one or more processors to perform operations comprising: receiving, at a real-time layer, first user data comprising a first user action at a first time, wherein the real-time layer includes a first real-time data graph associated with the first user data; determining a first identifier associated with the first user data; receiving, at the real-time layer, second user data comprising a second user action at a second time, wherein the real-time layer includes a second real-time data graph associated with the second user data; determining a second identifier associated with the second user data; determining that the first identifier corresponds to the second identifier; based on the first identifier and the second identifier corresponding, generating a unified real-time data graph based at least in part on the first real-time data graph and the second real-time data graph; based at least in part on the unified real-time data graph, determining real-time personalization data at a third time; and causing an output to be generated based at least in part on the real-time personalization data.

B. The system of paragraph A, wherein at least one of the first identifier or the second identifier comprise: a Hypertext Transfer Protocol (HTTP) cookie identifier; a device identifier; an authentication identifier; or an email identifier.

C. The system of paragraph A, wherein determining that the first identifier corresponds to the second identifier further comprises: determining a similarity between the first identifier and the second identifier; and determining, based at least in part on a policy, that the similarity meets or exceeds a threshold similarity.

D. The system of paragraph A, the operations further comprising determining an aggregation associated with the first user action and the second user action, wherein the real-time personalization data includes an indication of the aggregation.

E. The system of paragraph D, wherein the first user action and the second user action comprise at least one of: a browsing action, wherein the aggregation indicates a browsing history associated with an application; a browsing action associated with a product, wherein the aggregation indicates a browsing history associated with the product; or a financial transaction, wherein the aggregation indicates a lifetime value (LTV).

F. The system of paragraph A, wherein the first user action and the second user action are associated with a user profile, the operations further comprising: determining, based on at least one of the first real-time data graph or the second real-time data graph, an attribute associated with the user profile; determining, based at least in part on the attribute, a real-time segment associated with the user profile; and updating the at least one of the first real-time data graph or the second real-time data graph based at least in part on the real-time segment to generate an updated real-time data graph, wherein the real-time personalization data is further based on the updated real-time data graph.

G. The system of paragraph F, wherein the real-time segment is based at least in part on an aggregation associated with the first user action and the second user action.

H. The system of paragraph A, wherein the first user action and the second user action are associated with a user profile, the operations further comprising: determining, based at least in part on the unified real-time data graph, an attribute associated with the user profile; determining, based at least in part on the attribute, a real-time segment associated with the user profile; and updating the unified real-time data graph based at least in part on the real-time segment to generate an updated real-time data graph, wherein the real-time personalization data is further based on the updated real-time data graph.

I. One or more non transitory computer readable media storing instructions executable by one or more processors, wherein the instructions, when executed, cause the one or more processors to perform operations comprising: receiving, at a real-time layer, first user data comprising a first user action at a first time, wherein the real-time layer includes a first real-time data graph associated with the first user data; determining a first identifier associated with the first user data; receiving, at the real-time layer, second user data comprising a second user action at a second time, wherein the real-time layer includes a second real-time data graph associated with the second user data; determining a second identifier associated with the second user data; determining that the first identifier corresponds to the second identifier; based on the first identifier and the second identifier corresponding, generating a unified real-time data graph based at least in part on the first real-time data graph and the second real-time data graph; based at least in part on the unified real-time data graph, determining real-time personalization data at a third time; and causing an output to be generated based at least in part on the real-time personalization data.

J. The one or more non transitory computer readable media of paragraph I, wherein at least one of the first identifier or the second identifier comprise: a Hypertext Transfer Protocol (HTTP) cookie identifier; a device identifier; an authentication identifier; or an email identifier.

K. The one or more non transitory computer readable media of paragraph I, wherein determining that the first identifier corresponds to the second identifier further comprises: determining a similarity between the first identifier and the second identifier; and determining, based at least in part on a policy, that the similarity meets or exceeds a threshold similarity.

L. The one or more non transitory computer readable media of paragraph I, the operations further comprising determining an aggregation associated with the first user action and the second user action, wherein the real-time personalization data includes an indication of the aggregation.

M. The one or more non transitory computer readable media of paragraph L, wherein the first user action and the second user action comprise at least one of: a browsing action, wherein the aggregation indicates a browsing history associated with an application; a browsing action associated with a product, wherein the aggregation indicates a browsing history associated with the product; or a financial transaction, wherein the aggregation indicates a lifetime value (LTV).

N. The one or more non transitory computer readable media of paragraph I, wherein the first user action and the second user action are associated with a user profile, the operations further comprising: determining, based on at least one of the first real-time data graph or the second real-time data graph, an attribute associated with the user profile; determining, based at least in part on the attribute, a real-time segment associated with the user profile; and updating the at least one of the first real-time data graph or the second real-time data graph based at least in part on the real-time segment to generate an updated real-time data graph, wherein the real-time personalization data is further based on the updated real-time data graph.

O. The one or more non transitory computer readable media of paragraph N, wherein the real-time segment is based at least in part on an aggregation associated with the first user action and the second user action.

P. The one or more non transitory computer readable media of paragraph I, wherein the first user action and the second user action are associated with a user profile, the operations further comprising: determining, based at least in part on the unified real-time data graph, an attribute associated with the user profile; determining, based at least in part on the attribute, a real-time segment associated with the user profile; and updating the unified real-time data graph based at least in part on the real-time segment to generate an updated real-time data graph, wherein the real-time personalization data is further based on the updated real-time data graph.

Q. A method comprising: receiving, at a real-time layer, first user data comprising a first user action at a first time, wherein the real-time layer includes a first real-time data graph associated with the first user data; determining a first identifier associated with the first user data; receiving, at the real-time layer, second user data comprising a second user action at a second time, wherein the real-time layer includes a second real-time data graph associated with the second user data; determining a second identifier associated with the second user data; determining that the first identifier corresponds to the second identifier; based on the first identifier and the second identifier corresponding, generating a unified real-time data graph based at least in part on the first real-time data graph and the second real-time data graph; based at least in part on the unified real-time data graph, determining real-time personalization data at a third time; and causing an output to be generated based at least in part on the real-time personalization data.

R. The method of paragraph Q, the method further comprising determining an aggregation associated with the first user action and the second user action, wherein the real-time personalization data includes an indication of the aggregation.

S. The method of paragraph Q, wherein the first user action and the second user action are associated with a user profile, the method further comprising: determining, based on at least one of the first real-time data graph or the second real-time data graph, an attribute associated with the user profile; determining, based at least in part on the attribute, a real-time segment associated with the user profile; and updating the at least one of the first real-time data graph or the second real-time data graph based at least in part on the real-time segment to generate an updated real-time data graph, wherein the real-time personalization data is further based on the updated real-time data graph.

T. The method of paragraph Q, wherein the first user action and the second user action are associated with a user profile, the method further comprising: determining, based at least in part on the unified real-time data graph, an attribute associated with the user profile; determining, based at least in part on the attribute, a real-time segment associated with the user profile; and updating the unified real-time data graph based at least in part on the real-time segment to generate an updated real-time data graph, wherein the real-time personalization data is further based on the updated real-time data graph.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A system comprising:
one or more processors; and
one or more non-transitory computer-readable media storing computer-executable instructions that, when executed, cause the one or more processors to perform operations comprising:
receiving, at a real-time layer, first user data comprising a first user action at a first time, wherein the real-time layer includes a first real-time data graph from a storage layer and associated with the first user data, wherein the first user data is received by the real-time layer instead of the storage layer based at least in part on the real-time layer being associated with low latency processing instead of low data redundancy;
determining a first identifier associated with the first user data;
receiving, at the real-time layer, second user data comprising a second user action at a second time, wherein the real-time layer includes a second real-time data graph associated with the second user data;
determining a second identifier associated with the second user data;
determining that the first identifier corresponds to the second identifier;
based on the first identifier and the second identifier corresponding, generating a unified real-time data graph based at least in part on the first real-time data graph and the second real-time data graph;
based at least in part on the unified real-time data graph, determining real-time personalization data at a third time;
causing an output to be generated based at least in part on the real-time personalization data; and
based on at least one of the first user data or the second user data, updating a data graph of the storage layer, wherein the data graph of the storage layer is updated further based on the storage layer being associated with low data redundancy instead of low latency processing.

2. The system of claim 1, wherein at least one of the first identifier or the second identifier comprise:
a Hypertext Transfer Protocol (HTTP) cookie identifier;
a device identifier;
an authentication identifier; or
an email identifier.

3. The system of claim 1, wherein determining that the first identifier corresponds to the second identifier further comprises:
determining a similarity between the first identifier and the second identifier; and
determining, based at least in part on a policy, that the similarity meets or exceeds a threshold similarity.

4. The system of claim 1, the operations further comprising determining an aggregation associated with the first user action and the second user action, wherein the real-time personalization data includes an indication of the aggregation.

5. The system of claim 4, wherein the first user action and the second user action comprise at least one of:
a browsing action, wherein the aggregation indicates a browsing history associated with an application;
a browsing action associated with a product, wherein the aggregation indicates a browsing history associated with the product; or
a financial transaction, wherein the aggregation indicates a lifetime value (LTV).

6. The system of claim 1, wherein the first user action and the second user action are associated with a user profile, the operations further comprising:
determining, based on at least one of the first real-time data graph or the second real-time data graph, an attribute associated with the user profile;
determining, based at least in part on the attribute, a real-time segment associated with the user profile; and
updating the at least one of the first real-time data graph or the second real-time data graph based at least in part on the real-time segment to generate an updated real-time data graph,
wherein the real-time personalization data is further based on the updated real-time data graph.

7. The system of claim 6, wherein the real-time segment is based at least in part on an aggregation associated with the first user action and the second user action.

8. The system of claim 1, wherein the first user action and the second user action are associated with a user profile, the operations further comprising:
determining, based at least in part on the unified real-time data graph, an attribute associated with the user profile;
determining, based at least in part on the attribute, a real-time segment associated with the user profile; and
updating the unified real-time data graph based at least in part on the real-time segment to generate an updated real-time data graph,
wherein the real-time personalization data is further based on the updated real-time data graph.

9. One or more non-transitory computer-readable media storing instructions executable by one or more processors, wherein the instructions, when executed, cause the one or more processors to perform operations comprising:
receiving, at a real-time layer, first user data comprising a first user action at a first time, wherein the real-time layer includes a first real-time data graph from a storage layer and associated with the first user data, wherein the first user data is received by the real-time layer instead of the storage layer based at least in part on the real-time layer being associated with low latency processing instead of low data redundancy;
determining a first identifier associated with the first user data;
receiving, at the real-time layer, second user data comprising a second user action at a second time, wherein the real-time layer includes a second real-time data graph associated with the second user data;
determining a second identifier associated with the second user data;
determining that the first identifier corresponds to the second identifier;
based on the first identifier and the second identifier corresponding, generating a unified real-time data graph based at least in part on the first real-time data graph and the second real-time data graph;
based at least in part on the unified real-time data graph, determining real-time personalization data at a third time;
causing an output to be generated based at least in part on the real-time personalization data; and
based on at least one of the first user data or the second user data, updating a data graph of the storage layer, wherein the data graph of the storage layer is updated further based on the storage layer being associated with low data redundancy instead of low latency processing.

10. The one or more non-transitory computer-readable media of claim 9, wherein at least one of the first identifier or the second identifier comprise:
a Hypertext Transfer Protocol (HTTP) cookie identifier;
a device identifier;
an authentication identifier; or
an email identifier.

11. The one or more non-transitory computer-readable media of claim 9, wherein determining that the first identifier corresponds to the second identifier further comprises:
determining a similarity between the first identifier and the second identifier; and
determining, based at least in part on a policy, that the similarity meets or exceeds a threshold similarity.

12. The one or more non-transitory computer-readable media of claim 9, the operations further comprising determining an aggregation associated with the first user action and the second user action, wherein the real-time personalization data includes an indication of the aggregation.

13. The one or more non-transitory computer-readable media of claim 12, wherein the first user action and the second user action comprise at least one of:
a browsing action, wherein the aggregation indicates a browsing history associated with an application;
a browsing action associated with a product, wherein the aggregation indicates a browsing history associated with the product; or
a financial transaction, wherein the aggregation indicates a lifetime value (LTV).

14. The one or more non-transitory computer-readable media of claim 9, wherein the first user action and the second user action are associated with a user profile, the operations further comprising:
determining, based on at least one of the first real-time data graph or the second real-time data graph, an attribute associated with the user profile;
determining, based at least in part on the attribute, a real-time segment associated with the user profile; and
updating the at least one of the first real-time data graph or the second real-time data graph based at least in part on the real-time segment to generate an updated real-time data graph,
wherein the real-time personalization data is further based on the updated real-time data graph.

15. The one or more non-transitory computer-readable media of claim 14, wherein the real-time segment is based at least in part on an aggregation associated with the first user action and the second user action.

16. The one or more non-transitory computer-readable media of claim 9, wherein the first user action and the second user action are associated with a user profile, the operations further comprising:
determining, based at least in part on the unified real-time data graph, an attribute associated with the user profile;
determining, based at least in part on the attribute, a real-time segment associated with the user profile; and
updating the unified real-time data graph based at least in part on the real-time segment to generate an updated real-time data graph,
wherein the real-time personalization data is further based on the updated real-time data graph.

17. A method comprising:
receiving, at a real-time layer, first user data comprising a first user action at a first time, wherein the real-time layer includes a first real-time data graph from a storage layer and associated with the first user data, wherein the first user data is received by the real-time layer instead of the storage layer based at least in part on the real-time layer being associated with low latency processing instead of low data redundancy;
determining a first identifier associated with the first user data;
receiving, at the real-time layer, second user data comprising a second user action at a second time, wherein the real-time layer includes a second real-time data graph associated with the second user data;
determining a second identifier associated with the second user data;
determining that the first identifier corresponds to the second identifier;
based on the first identifier and the second identifier corresponding, generating a unified real-time data graph based at least in part on the first real-time data graph and the second real-time data graph;
based at least in part on the unified real-time data graph, determining real-time personalization data at a third time;
causing an output to be generated based at least in part on the real-time personalization data; and
based on at least one of the first user data or the second user data, updating a data graph of the storage layer, wherein the data graph of the storage layer is updated further based on the storage layer being associated with low data redundancy instead of low latency processing.

18. The method of claim 17, the method further comprising determining an aggregation associated with the first user action and the second user action, wherein the real-time personalization data includes an indication of the aggregation.

19. The method of claim 17, wherein the first user action and the second user action are associated with a user profile, the method further comprising:
determining, based on at least one of the first real-time data graph or the second real-time data graph, an attribute associated with the user profile;
determining, based at least in part on the attribute, a real-time segment associated with the user profile; and
updating the at least one of the first real-time data graph or the second real-time data graph based at least in part on the real-time segment to generate an updated real-time data graph,
wherein the real-time personalization data is further based on the updated real-time data graph.

20. The method of claim 17, wherein the first user action and the second user action are associated with a user profile, the method further comprising:
determining, based at least in part on the unified real-time data graph, an attribute associated with the user profile;
determining, based at least in part on the attribute, a real-time segment associated with the user profile; and
updating the unified real-time data graph based at least in part on the real-time segment to generate an updated real-time data graph,
wherein the real-time personalization data is further based on the updated real-time data graph.
